(19) United States
(12) Patent Application Publication
(10) Pub. No.: US 2010/0080945 A1
(43) Pub. Date: Apr. 1, 2010

(54) ADHESIVE LAYER FOR A BUBBLE-FREE ADHESIVE BOND

(75) Inventors: Klaus Kleinhoff, Rodenberg (DE); Christoph Nagel, Hamburg (DE)

Correspondence Address: Hildebrand, Christa;Norris McLaughlin & Marcus PA, 875 Third Avenue, 8th Floor, New York, NY, 10022, US

(73) Assignee: TESA SE, Hamburg (DE)

(21) Appl. No.: 12/519,544

(22) PCT Filed: Dec. 7, 2007
(86) PCT No.: PCT/EP2007/063501

§ 371 Date: Jul. 7, 2009

(30) Foreign Application Priority Data
Dec. 22, 2006 (DE) 10 2006 062 247.2

(51) Int. Cl. B32B 37/12; B32B 3/26

(52) U.S. Cl. 428/41.8; 428/317.5; 428/315.5; 428/40.1; 156/87

(57) ABSTRACT

The invention relates to an adhesive layer for a bubble-free adhesive bond, the adhesive layer being formed from an adhesive and there being at least one channel made in the surface of the adhesive, characterized in that the adhesive has expanded, and also to a method of producing a sheet-like structure that bonds without bubbles, wherein an adhesive is applied as an adhesive layer to a functional layer and wherein at least one channel is made in the surface of the adhesive, characterized in that the adhesive is expanded.

The invention relates to
an adhesive layer for a bubble-free bond, having at least one channel made superficially in the adhesive of which the adhesive layer is formed,
a sheetlike structure for a bubble-free bond, and
a method of producing the sheetlike structure for a bubble-free bond.

For the purpose of this application, the term “sheetlike structure” includes “tapes”, i.e., those articles whose lengthwise extent is substantially longer than their widthwise extent. When equipped with a self-adhesive, such tapes are typically referred to as “adhesive tapes”. However, the term “sheetlike structure” also includes those structures whose width is of the same order of magnitude as their length, either because they are diecuts, which are sold in ready-diecut form with any of a very wide variety of outlines, or because they are sections cut to size from substantially larger balls or rolls that are sold, and which are cut to size by the users themselves. “Sheetlike structure”, therefore, is intended only to express the fact that the thickness of such a structure is small in relation to its width and length.

One example of such sheetlike structures in the form of diecuts are the sheet sections which are nowadays frequently used to obtain a more stretched approximation to the B pillars of automobile bodies. In black or dark gray, at least when viewed from a distance, they emphasize the cutoff point between the window area of the front door and the window that is behind it in the direction of travel, provided that they do in fact conform perfectly to the contour of the B pillar, something which requires not only a precise diecut contour and an accurate bonding attachment but also requires the surface to be free of dimples, for which purpose it is necessary for the adhesive bond to be made without bubbles.

Numerous other applications as well employ sheetlike adhesive structures such as, for instance, adhesive sheets or adhesive tapes, which are applied to a substrate in order to join it adhesively to other elements, in order to protect it or for decorative purposes. On one side or on both sides, such adhesive articles have an adhesive layer comprising an adhesive by means of which the adhesive article is to be attached to the substrate.

A frequent occurrence during the adhesive bonding of the adhesive articles, however, is the inclusion of a fluid, such as air, for example, at the bond face, i.e., at the face of the adhesive bond between the adhesive on the one hand and the substrate on the other, with the fluid—air, for example—remaining there in the form of a bubble. This occurs in particular when adhesive contact between the adhesive article and the substrate is not produced starting from a single point or from a line without annular closure and then extending over the entire bond face. Instead, a closed curvilinear line is formed in the course of adhesive bonding, and a coherent bond face has formed on this line, while inside this line there has still been no full-area adhesive contact. The air or other fluid or fluid mixture located within this curvilinear line has no possibility to escape, and is enclosed there.

The formation of bubbles in this way becomes all the more frequent as the bond face increases in size. The adhesive regions which lie outside the closed curvilinear line can often still be bonded to the substrate in a bubble-free way. However, the fluid located inside the closed curvilinear line is enclosed there and usually cannot be taken off, even perpendicularly to the bond face, since commonly neither the substrates to be bonded nor the carrier materials of the adhesive article are permeable to air.

Fluid inclusions or fluid bubbles of this kind are unwanted in the case of the majority of adhesive bonds. Bubble-free joining, i.e., full-area joining, is particularly important in the case of those adhesive bonds which are required to have a technically uniform height (such as when mounting printing plates in the printing industry, for instance), or for which the visual quality of the adhesive bond is important (as in the case, for instance, of protective films on optical devices, or decorative covers made of adhesive sheets).

As a consequence of the requirements imposed on the geometry and the carrier material of the adhesive articles, it is difficult in some cases to ensure bubble-free bonding right at the stage of forming the adhesive bond itself. It is sensible, accordingly, to be able to remove a bubble of fluid in an aftertreatment of the adhesive bond as well. The most common aftertreatment measure is the “pressing out” of the bubble of fluid from the bond face; in this case the fluid inclusion is moved, by the exertion of a pressure onto the bubble of fluid, toward the edge of the bond face. For that purpose it is necessary for the adhesive contact already formed around the bubble to be parted again in regions, which can be accomplished only in the case of weak adhesive bonds. Furthermore, a relatively large force has to be applied in order to transport the bubble of fluid beneath the flat bonding face to the edge. For the entire transport procedure, therefore, a “forceful pressing-out” is needed in order to overcome the resistance offered to the bubble of fluid by the already bonded bond face in the course of pressing out. Occasionally, in the course of this procedure, the substrate or the adhesive article is damaged.

EP 0 951 518 B1 discloses bubble-freely bonding articles in which the adhesive exhibits permanently uninterrupted channels with a low cross-sectional area.

Adhesive articles referred to as “bubble-freely bonding” here are those which are applied to the substrate and bond to it, the adhesive bond having no fluid bubbles enclosed in the bond face, without aftertreatment or at most after simple aftertreatment.

Since the uninterrupted channels are intended to be situated at what is subsequently the bond face, they are typically located on the side of the adhesive that is brought into contact with the substrate for the purpose of bonding—that is, they are made superficially in the adhesive. The channels enable the fluid that is enclosed at the bond face to be passed toward the edge of the bond face, without transport through the channels requiring that a joint already produced between the adhesive article and the substrate be parted locally. Transport through the uninterrupted channels, accordingly, is “soft pressing-out” with only low pressure, in other words, a low-pressure or even virtually pressure-free pressing-out procedure. On account of this easing, the bubble-removing action of pressing-out generally comes about, even without a dedicated workstep, when the adhesive sheetlike structure itself is applied.

The easing of the pressing-out derives, in a manner known per se, from the fact that the greatest part of the distance the fluid must travel along the bond face is overcome with virtually no resistance; forceful pressing-out, in which an adhesive bond that has already formed is parted and re-made, is necessary only for the short distance a bubble of fluid must travel until it reaches the closest channel. Since this distance is significantly shorter, in general, than the distance in the case of complete, forceful pressing-out, it is possible to remove a bubble of fluid that has occurred in the course of bonding with an overall lower pressure being exerted and, in particular, with a smaller amount of effort.

A disadvantage of such systems is that the adhesives used must be sufficiently dimensionally stable, since the channels must still be uninterrupted just a short time after the bonding of the adhesive article to the substrate. It is therefore only possible to use “hard” adhesives, in other words highly cohesive adhesives with only small viscous fractions, since otherwise there would be a risk that the channels, owing to a viscous flow—as for instance when the adhesive article is pressed onto the substrate—could be permanently closed and would no longer be available for transport of the fluid bubbles toward the edge of the article. Hard adhesives of this kind, however, frequently exhibit low levels of adhesion and tack, and accordingly make the job of the assembly worker more difficult by necessitating a relatively high and long-lasting pressure to be applied in order to produce the adhesive bond, and/or by necessitating preheating of the substrate to be bonded.

With systems of this kind, furthermore, it is necessary to limit the depth of the channels, since otherwise it is impossible to meet the customer requirement for the venting channels not to “show through” on the side of the bonded sheetlike structure that is opposite the adhesive layer; instead, these channels are to be invisible on the reverse side. For instance, the aforementioned EP 0 951 518 B1 refers to a limitation to 45 μm.

It is an object of the invention to specify an adhesive layer for a bubble-free bond that has a relatively high tack and hence relatively easy mountability. Going hand in hand with this is the object of providing a sheetlike structure for a bubble-free bond, and also a process for producing the sheetlike structure.

In the case of an adhesive layer for a bubble-free bond having the features of the preamble of claim 1, the present object is achieved through the features of the characterizing clause of claim 1. Solutions of equal standing are provided by the sheetlike structure according to claim 19 and also by a method of producing the sheetlike structure according to claim 28. Preferred embodiments and developments are subject matter of the respective dependent claims.

Provided in accordance with the invention is an adhesive layer for a bubble-free bond for which, in the adhesive, at least one channel has been made superficially in the adhesive. The making of the channel “superficially” means that the channel is arranged on the side of the adhesive that comes into contact with the substrate for the purpose of adhesive bonding. Moreover, the channel is open toward the substrate, in order to allow the pressing-out of any fluid bubble occurring in the course of adhesive bonding.

In order to allow a greater depth of channel in relation to the proposed solutions to date, without having to achieve this by increasing the amount (meant here in the sense of the physical term “mass”) of adhesive to be applied, the invention provides that the adhesive is expanded. The expansion of the adhesive can be brought about in a wide variety of ways, as for example by the blowing-in of a gas or gas mixture which does not react disadvantageously with the adhesive, such as by blowing-in of carbon dioxide, for example, but preferably by the introduction of what are called microballoons, which expand substantially only after a processing step—heating, for example.

Expansion by microballoons gives the mixture of adhesive and microballoons a greater cohesiveness macroscopically—that is, averaged over a space whose edge extent is significantly larger than the diameter of one microballoon—than that of the adhesive on its own.

The invention does not alter anything about the fundamental behavior of any permanently tacky adhesive, to the effect that it has a certain willingness to flow, which might be disruptive if the channels “flow together” more or less gradually, in other words lose their capacity to be able to remove fluids, and yet as a result of the increased depth of channel, preferably from 50 to 100 μm, more preferably from 60 to 80 μm, the adhesive has to travel larger flow pathways until the channels become blocked, and this, accordingly, takes longer. It is sufficient if the flow time until the channels become blocked is longer than the typical application time, in other words the time from removal of the structured liner that preserves the structure of the adhesive through to the completion of the application—and, where necessary, pressing-out of fluid—of the adhesive material onto the substrate.

If, as is preferred, the expansion of adhesive takes place by means of microballoons, the effect of lengthening the flow pathway is additionally accompanied, further, by the flow-throttling effect of the microballoons.

The term “adhesive” in the sense of claim 1 can be read both in the narrower sense as applying to the adhesive itself—in other words to the mixture of polymers and, where appropriate, resins, in addition to conventional ageing inhibitors and further conventional additives, colors, etc.—and, in the wider sense, to refer to the mixture of this adhesive with microballoons.

Because an increase of this magnitude in the highest allowable application time for satisfactory fluid removal as is made possible by the invention is unnecessary in the majority of applications, particularly in the case of the relatively small adhesive-sheet diecuts for “hiding” the B-pillars in many common automobile body designs (in the case of the Skoda Roomster, moreover, it is the A-pillar instead), it is possible to use an adhesive mixture which is more ready to flow per se; as a result, it is possible to set a higher adhesion and initial tack, facilitating the application of inventive products for the assembly worker.

As a starting material for the expanded adhesive it is possible to use any desired, customary adhesives. Such adhesives typically comprise at least one adhesion-promoting component, which may have constituents such as tackifier resins and structure-controlling constituents such as plasticizers, crosslinkers or crosslinker assistants. The adhesive may further comprise adjuvants such as colorants, fillers or the like. It is preferred to employ pressure-sensitive self-adhesives for which adhesive bonding to the substrate is achieved generally simply by the exertion of a gentle pressure on the adhesive (and/or its carrier).

Pressure-sensitive self-adhesives of this kind which enter into a bond with a substrate immediately after they have been contacted with it are also referred to as PSAs. A pressure-sensitive self-adhesive may be prepared from a solution or a dispersion.

However, the invention also functions with adhesives that are hard at room temperature, examples being those also referred to as hotmelts.

Preferred self-adhesives or adhesives are those which are based on polyacrylates, natural rubber, synthetic rubbers and/or polyurethanes or other thermoplastic or non-thermoplastic elastomers.

As already mentioned, the expansion of the adhesive may be obtained in a variety of ways, as for example by foaming. In one variant of foaming, expanding gas, more particularly carbon dioxide, is introduced into the adhesive. The expanding gas then forms pores in the adhesive that lead to the desired expansion of the adhesive. Alternatively to the introduction of an expanding gas, the adhesive may comprise substances which release expanding gases into the adhesive and so lead to the pore formation and expansion. The release of the expanding gases may take place immediately after these substances have been mixed into the adhesive, or else after a triggering step, such as an increase in temperature.

Alternatively the expansion of the adhesive may be achieved by means of a chemical reaction in the course of which there is an increase in volume. In this case the expansion may be triggered simply by the mixing of corresponding substances into the adhesive, or else by a subsequent triggering step. Furthermore, the expansion of the adhesive may be achieved through a combination of different expansion possibilities, particularly those described above.

With particular preference, however, the expansion of the adhesive is obtained by mixing microballoons into the adhesive that undergo an increase in volume after a corresponding triggering step. Microballoons are balloons which are initially small and have a shell filled with an expandable substance. As a result of a triggering step, such as an increase in temperature, the shell is softened and the internal balloon pressure is increased, whereupon the substance that is present in the shell causes the shell to expand. As a result there is the desired increase in volume.

Microballoons used are typically tiny balloons made of a thermoplastic polymer shell filled with a substance, such as isobutane, for example, in their internal cavity.

A microballoon-filled adhesive layer exhibits the property that the unwanted flowing-together of the channels is reduced. The mixing of microballoons into adhesives is described comprehensively in DE 10 2004 037 910 A1, whose disclosure content is hereby incorporated and so made part of the subject matter of the present patent application.

In order to minimize the mass of the applied adhesive, the adhesive ought to have undergone expansion such that the specific weight of the expanded adhesive is not more than about 70% of the weight of a layer of equal thickness of an unexpanded adhesive. To put it the other way round: if an unexpanded adhesive were to be applied in the same layer thickness, the mass of applied adhesive would be higher by just under 43%.

In a preferred embodiment the specific weight of the expanded adhesive is below about 50%, very preferably between about 35% and about 15%, of the weight of an unexpanded adhesive of equal thickness. An expansion of this degree enables not only increased channel depth and/or more adhesively formulated adhesive but also, indeed, a reduction in mass in spite of increased channel depth.

The channels are formed in the adhesive preferably by embossing, as for example by means of a structured liner. An alternative possibility for forming the channels in the adhesive is to make them by means of a local input of energy such as laser irradiation. In that case as well, however, the general approach ought to be to place a liner which has such structuring onto the adhesive tape with the freshly produced channels, the structuring being at least roughly complementary to the surface of the adhesive, in order in this way to preserve the structuring for a long period of storage; this rule can be departed from if, as a result of the aforementioned input of energy or other means as well, the channel walls have solidified in such a way that they do not flow together during the storage and transport from the adhesive tape plant to the adhesive tape customer.

Even if such a local input of energy, more particularly laser irradiation, onto the channel walls would not completely prevent their flow, it is nevertheless suitable for precrosslinking the channel walls in the adhesive, and in that way additionally slowing down the flow together of the channels. This allows adhesives with a particularly high tack to be used for forming adhesive layers of the invention.

Moreover, the invention allows the above-described adhesive layer with channels and expanded adhesive to be used to produce a bubble-free bond. For that purpose the adhesive is applied directly to the surface of a substrate or else to a sheetlike structure, more particularly a flexible sheetlike structure such as, for instance, an adhesive sheet, an adhesive tape or an adhesive label, which may be conventionally designed. In particular the invention allows the adhesive to be used to produce a sheetlike structure of this kind for a bubble-free bond.

The sheetlike structure provided in accordance with the invention for a bubble-free bond has a carrier and/or another functional layer, and a layer joined to the carrier or to the other functional layer. In the text below, the term functional layer also comprehends the carrier. The joining of the two layers (functional layer and adhesive layer) can be achieved via any desired joining methods, most simply by adhesively bonding the adhesive layer on the functional layer to the side of the adhesive layer that is opposite the bond face, or else by a deliberate chemical linking of the functional layer with the adhesive layer, for which purpose the functional layer and/or the adhesive layer can be adapted chemically by modification of the corresponding surface. Sheetlike structures of this kind may take a variety of forms, examples being a tape, label or sheet.

A carrier of this kind may be composed of customary materials, as for example of polymers such as polyesters, polypropylene, polyethylene, polyamide or polyvinyl chloride, of woven, knitted, laid and nonwoven fabrics, paper, foams and the like, and also of laminates of these materials. Such a carrier may take the form of a carrier joined permanently to the adhesive layer, as for conventional adhesive sheets and adhesive tapes, for example, or else may be composed of a temporary carrier which is joined in use merely for a certain time to the adhesive layer, as for example, for the application of the adhesive sheetlike structure to a substrate, and is removed again thereafter. Examples of temporary carriers of this kind are liners, more particularly in-process liners, of the kind customary in adhesive technology, such as siliconized release papers, for instance.

A functional layer may, furthermore, also have a further adhesive layer which likewise comprises the adhesive described above, thus producing a double-sidedly adhesive sheetlike structure. Alternatively this second adhesive layer may also have adhesive properties modified relative to the first adhesive layer, in order, for example, to obtain different adhesion to a different, second substrate. Sheetlike structures of this kind can be used in this form at the premises of the customer or else may be used as adhesive transfer tapes. As will be appreciated, a functional layer may also have two or more individual such functional elements—for instance, a permanent carrier, on which there is a second adhesive layer applied, which in turn is lined by a temporary carrier. Customary constituents of such functional layers are, for instance, one or more plies of films, woven fabrics, nonwoven fabrics, foams, delayed-release structures for particular additives or actives, and nonstick systems.

In a preferred embodiment, the adhesive layer may be lined temporarily with a liner on the side facing away from the functional layer, in other words on its top face, the liner having a substantially smooth surface; in other words, the modification of the liner to the channel structure for the purpose of its support prior to use, in order to prevent flowing together, is unnecessary. This is the case more particularly when the channel walls are precrosslinked.

Lining with a smooth liner is particularly advantageous in the case of single-sided adhesive tapes, since in that way the functional layer of the sheetlike structure can be utilized diversely. The functional layer may be formed on one side as a carrier of a first adhesive layer, and on its reverse as a liner for a second adhesive layer.

Designing the functional layer as a liner may be achieved by means of a suitable anti-adhesive coating, such as a coating with silicone rubber, for example. A sheetlike structure of this kind can be wound up as a roll without an additional liner, since the functional layer of the sheetlike structure takes over the function of such a liner. A sheetlike structure of this kind may be used, for example, for single-sided adhesive tapes, such as, for example, so-called blackout tapes (BOT) for laminating parts of automobile bodies, particularly the B pillar.

As an alternative to the lining with a smooth liner, the adhesive layer may be lined with a liner which is formed as the shape negative with respect to the surface structure of the adhesive layer—that is, which has a structure which engages into the channel and thus supports and preserves the channel structure until the liner is removed. A sheetlike structure of this kind is especially suitable for double-sided adhesive tapes, in the application for adhesively bonding printing plates, for example.

It is also particularly important that, by virtue of the expansion of the adhesive, the adhesive layer exhibits an enhanced compressibility in the z direction, i.e., perpendicular to the adhesive layer. As a result, the additional cushioning layer, generally composed of foam, that is needed in certain applications, such as in adhesive bonding of printing plates, for example, is not necessary. The thickness of the foam layer can therefore be reduced by the fraction by which the adhesive has been increased, or may possibly replace the cushioning layer completely. This additional benefit provides not only a cost saving, which is able to compensate for the extra cost and complexity of introducing the microballoons, but also makes it easier to comply with the existing dimensional regime in the printing-plant operations. The sheetlike structure of the invention is thus suitable in particular for use in the adhesive bonding of printing plates, and particularly, indeed, for plate mounting.

The invention also provides a process for producing a sheetlike structure for a bubble-free bond. In this process, the adhesive is applied as an adhesive layer to a functional layer, and at least one channel is made superficially in the adhesive. In accordance with the invention, moreover, the adhesive is expanded, it being possible for the expansion of the adhesive to take place prior to the application of the adhesive to the functional layer, following this application but before the channels are made, or after the channel has been made. Of these possibilities, the latter is particularly preferred. Because it is possible, in the course of the concluded expansion, for the cross section of the previously embossed channels to alter to a greater or lesser extent, depending on the degree of expansion, a) measures ought to taken which inhibit such changes, and/or b) measurements ought to be selected which already take account of such subsequent changes.

The preferred measure according to a) is to leave the embossing tool, which engages form-fittingly into the embossed adhesive layer, in that layer until expansion is at an end. The preferred measure according to b) is to give the initially embossed channels a greater width and a greater angle of widening than those which subsequently develop after expansion has taken place.

The expansion of the adhesive may take place in a variety of ways. Particularly suitable for this purpose is the above-described foaming of the adhesive, for example, by the introduction of an expanding gas or by the mixing-in of a substance comprising expanding gases, with this substance subsequently releasing an expanding gas. The release of the expanding gas may take place actually during the mixing of this substance into the adhesive, or after a suitable triggering step, such as the input of energy. Furthermore, the expansion of the adhesive may also take place by mixing-in of chemically reactive substances, with an increase in volume being achieved through a chemical reaction. The chemical reaction may take place directly as a result of or during mixing into the adhesive, or may likewise be activated by a triggering step.

In a particularly preferred embodiment of the process, the expansion of adhesive takes place by the mixing-in of microballoons and the subsequent triggering of the expansion, for example, by an input of energy such as an increase in temperature.

Where the adhesive is expanded by means of microballoons, these are preferably mixed into the adhesive before the adhesive is applied as an adhesive layer to the functional layer. In this case, the feature is exploited that the microballoons, in their unexpanded state, have a mechanical resistance, by virtue of their substantially smaller area for attack and also by virtue of the wall thickness being greater than in the expanded state, which is such that the majority of the microballoons withstand intact the shearing loads that occur in the course of mixing and application by spreading or by calandering.

For a good visual quality of the adhesive bond, and also for a uniform height of the adhesive layer, it is particularly advantageous if the adhesive is expanded homogeneously. This is preferably achieved by distributing the expanding gas, the substances comprising expanding gas, the microballoons and/or the chemically reactive substances substantially homogeneously in the adhesive, by means of a corresponding mixing operation, for example.

With particular preference the microballoons are in fact expanded only after the channels have been made in the adhesive, in order as far as possible to prevent damage to the microballoons when the channels are being made.

It is possible to provide, moreover, for the application to the first adhesive layer, even prior to the making of the channels, of a second, extremely thin adhesive layer which comprises no expandable or expanded adhesive. A result of this is the “extremely small covering”. That is, the distance between the peripherally adjacent pore and the periphery of the adhesive layer enlarges, in certain circumstances pore formation at the surface first is avoided completely. Channels are then made equally in the two adhesive layers arranged one above the other.

Alternatively, however, it is also possible to provide for the adhesive not to be expanded superficially, in other words for there to be no activation of the expansion locally.

A particularly suitable process step for making the channels in the adhesive is that of embossing. This can be done, for example, by applying a structured liner to the adhesive, so that the structure of the liner is embossed in the form of channels in the adhesive. The structured liner is a shape negative of the surface structure of the adhesive layer. Alternatively or additionally, the channels may also be made and/or stabilized in the adhesive by means of a local input of energy, such as by means of local laser irradiation, for example.

In the method of producing a bubble-freely bonding sheetlike structure, it is particularly advantageous if the channel walls, after having been made in the adhesive, are precrosslinked by means of a local input of energy. This further increases the stability of the channel walls, and so the channels are retained, and flowing-together is prevented, even on prolonged storage of the sheetlike structure. The precrosslinking may be achieved in particular by laser irradiation.

Further details, features, objectives and advantages of the present invention will be elucidated in more detail below with reference to a drawing of preferred exemplary embodiments. In the drawing

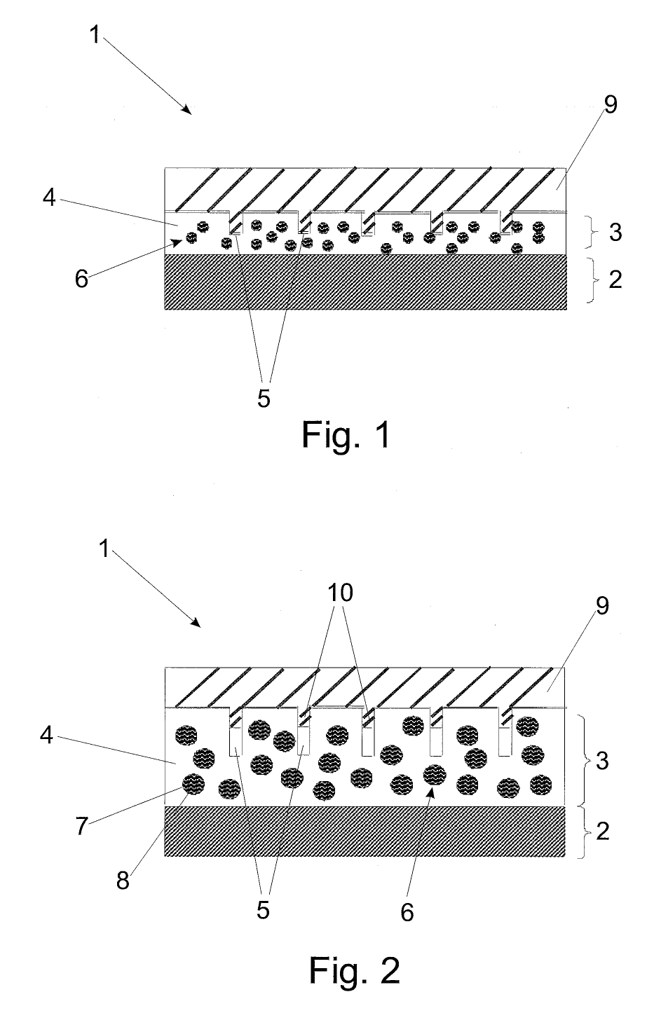

FIG. 1 shows a precursor product for the production of a bubble-freely bonding sheetlike structure, namely after application of adhesive and embossing of channels but before expansion,

FIG. 2 shows the sheetlike structure from FIG. 1 after expansion,

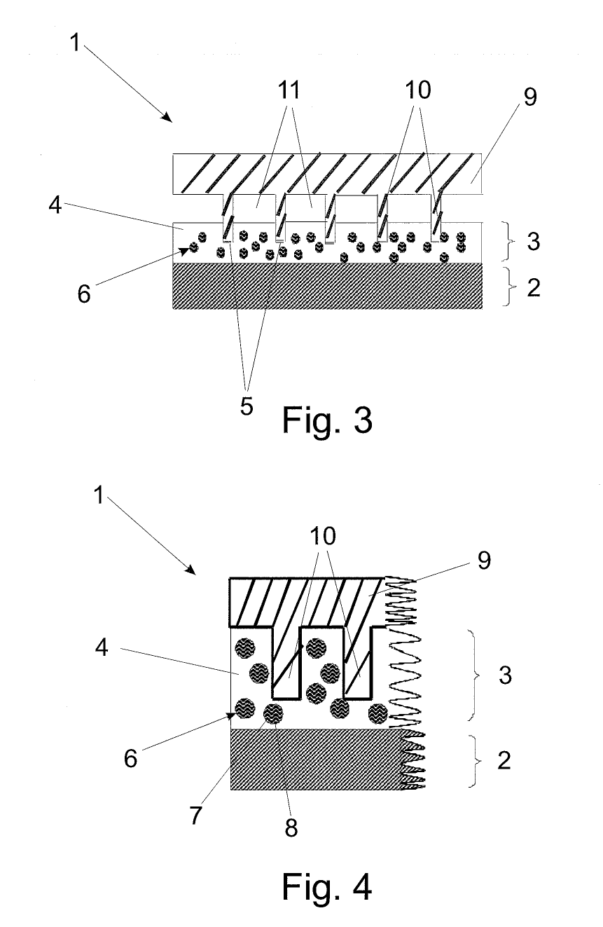

FIG. 3, as a further exemplary embodiment, shows another precursor product for the production of a bubble-freely bonding sheetlike structure, before expansion,

FIG. 4 shows the sheetlike structure from FIG. 3 after expansion,

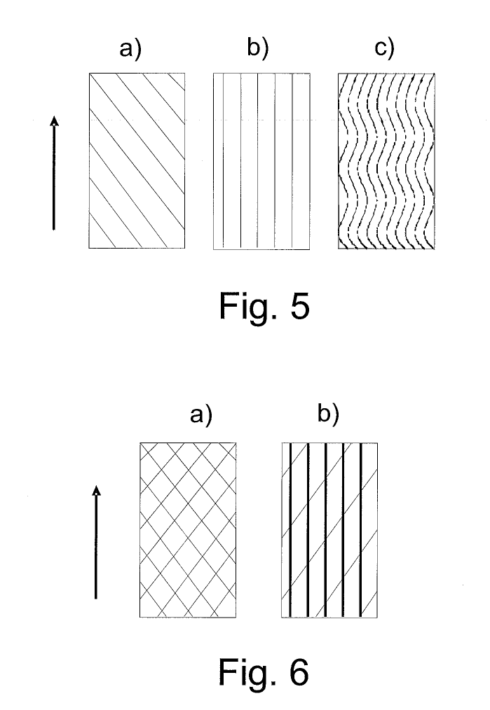

FIG. 5 shows four schematic plan views of an adhesive layer with different designs of two or more nonintersecting channels,

FIG. 6 shows three schematic plan views of an adhesive layer with different designs of two or more intersecting channels,

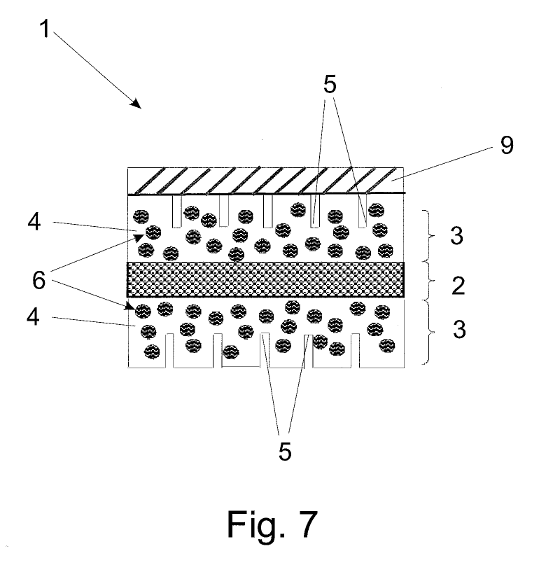

FIG. 7 shows another, double-sidedly adhesive exemplary embodiment of a bubble-freely bonding sheetlike structure.

FIG. 1 shows a sheetlike structure 1 having a functional layer 2 and an adhesive layer 3 joined to the functional layer 2. The functional layer 2 is configured here as a carrier of the adhesive layer 3. The adhesive layer 3 comprises an adhesive 4. Made in the adhesive layer 3 are a plurality of channels 5 which extend parallel to one another. FIG. 1 shows the precursor product for a bubble-freely bonding sheetlike structure 1 before, and FIG. 2 the same sheetlike structure 1 after, the expansion of the adhesive 4.

The expansion of the adhesive 4 that is shown in FIG. 2 is permanent—that is, it remains even after adhesive bonding to a substrate. The expansion of the adhesive 4 produces a compressibility which is increased relative to an unexpanded adhesive. As a result it is possible to omit the cushioning layer in the sheetlike structure 1 that is needed for certain

As is preferred, the expanding of the adhesive 4 in the case of the sheetlike structure according to FIG. 2 is brought about by means of microballoons 6. The microballoons 6 have a shell 7 and, within the shell 7, a substance 8 which undergoes an increase in volume after a triggering step. The shell 7 is formed as thermoplastic polymer shell made of polyacrylonitrile, for example. The substance 8 is in this case isobutane. As a result of an increase in temperature as a triggering step, the thermoplastic polymer shell 7 softens, and the substance 8 expands. There is a considerable rise in the volume of the micro-balloons 6, and hence the adhesive 4 expands (FIG. 2).

As shown schematically by FIG. 2, the expansion, even with a usual quality of adhesive per square meter, allows a relatively thick adhesive layer 4 and so creates the fundamental prerequisite for deep channels 5 in the adhesive layer.

In FIGS. 1 and 2 it is shown that the adhesive layer 3 is lined with a liner 9. The liner 9 has projections 10 which protrude into the channels 5 in the adhesive 4. The channels 5 in the adhesive 4 were made by means of the liner 9, the liner 9 being placed with its projections 10 onto the adhesive 4 and the channels 5 thus being embossed into the adhesive 4 by the projections 10 of the liner 9. Subsequently, the adhesive 4 was expanded, thereby enlarging the channel depth of the adhesive 4, as is also evident from looking at FIG. 1 and FIG. 2 together.

As an alternative or addition to the embossing of the channels 5 into the adhesive 4, local irradiation of the adhesive 4 by means of a laser is appropriate. In that case the channels 5 are generated and/or stabilized in the adhesive 4 by the laser irradiation.

The depth of the channels 5 after the expansion of the adhesive 4 is greater than 45 μm, preferably greater than about 60 μm, more preferably greater than about 70 μm. Here, and very preferably, the depth of the channels 5 is about 90 μm. The thickness of the adhesive layer here is about 130 μm. As a maximum size, the depth of the channels 5 ought not to be more than about 140 μm.

FIG. 2 shows further that the thickness of the adhesive layer here is approximately the same as the depth of the channels 5, whereas in the case of the embodiment of FIG. 4 it is only about 30% greater.

FIG. 4 shows a further embodiment of a bubble-freely bonding sheetlike structure 1 of the invention, and FIG. 3 shows the associated precursor product. This embodiment differs from the embodiment according to FIGS. 1, 2 and others in that the liner 9 has longer projections 10 as compared with the liner shown in FIGS. 1 and 2. The length of these projections 10 is made such that they almost fully fill the channels 5 even after the expansion of the adhesive 4. They therefore ensure that the channel structure is retained when the adhesive 4 is expanded. As a corollary of this, however, it is necessary to accept that this liner is regulated or controlled exactly in accordance with the height, in order first of all—in other words, prior to the expansion—for cavities 11 actually to remain, and in order that the long projections 10 do not puncture adhesive layer 3.

In section, FIG. 5 and FIG. 6 show plan views of adhesive layers with different designs of channels 5. The two-dimensional orientation of the adhesive layers is in each case in the plane of the depiction; the production direction is indicated on the left by an arrow. From all of the arrangements it is apparent that the adhesive layer has in each case a plurality of channels 5. This is advantageous in order to ensure an extremely short path for a bubble of fluid to a channel 5, in order to make the pressing-out of fluid bubbles as simple as possible. However, it is also necessary not to provide too many channels 5, so as not to produce an excessive reduction in the bond strength.

Depicted in FIG. 5 are arrangements in which the channels 5 do not intersect. They are in each case arranged with a uniform spacing parallel to one another. In FIG. 5a, the channels 5 extend in a direction oblique to the production direction; in FIG. 5b the channels 5 extend in the production direction; and in FIG. 5c the threads extend in a wave form longitudinally with respect to the production direction.

Depicted in FIG. 6 are arrangements in which there are two sets of channels 5 provided that intersect. Within each set, the channels 5 run each essentially at the same distance. In FIG. 6a, the channels 5 of the two sets run obliquely with respect to the production direction, and in FIG. 6b the channels of the first set run in the production direction and the channels of the second set run obliquely thereto. Whereas, in FIGS. 6a and 6b, the channels of the two sets have in each case the same distance between two channels 5, in FIG. 6b the distances of the channels 5 in the two sets are different.

FIG. 7 shows a further bubble-freely bonding sheetlike structure 1, in which one adhesive layer 3 in each case is joined on both sides to the functional layer 2. Both adhesive layers 3 are configured in accordance with the description above. Furthermore, it is shown that one of the adhesive layers 3 is lined with a liner 9 which has a substantially smooth surface toward the adhesive 4. Accordingly, the liner 9 here does not serve to support the channel structure, but merely to line the adhesive layer 3. This is possible in particular when the side walls of the channels 5 are precrosslinked.

1-41. (canceled)

42. An adhesive layer for a bubble-free adhesive bond in a sheet-like structure, the adhesive layer comprises
a top and a bottom surface,
at least one channel disposed in the top surface of the adhesive layer and wherein the adhesive layer is an expanded layer.

43. The adhesive layer of claim 42, wherein the adhesive layer is a foamed layer.

44. The adhesive layer of claim 43, wherein the adhesive layer is expanded by blowing-in expanding gas.

45. The adhesive layer of claim 43, wherein the adhesive layer is substantially pore-free on the surface.

46. The adhesive layer of claim 44, wherein expended gas is carbon dioxide.

47. The adhesive layer of claim 43, wherein the adhesive layer comprises a substance having the capacity of releasing expanding gases.

48. The adhesive layer of claim 42, wherein the adhesive layer includes microballoons.

49. The adhesive layer of claim 48, wherein the microballoons have a shell, holding an expanded substance.

50. The adhesive layer of claim 49, wherein the shell is a thermoplastic polymer shell.

51. The adhesive layer of claim 50, wherein the thermoplastic polymer shell is polyacrylonitrile.

52. The adhesive layer of claim 51, wherein the expanded substance is isobutane.

53. The adhesive layer of claim 42, wherein the expended layer includes substances which have expanded due to chemical reaction.

54. The adhesive layer of claim 44, wherein the expending gas is distributed substantially homogeneously in the adhesive layer.

55. The adhesive layer of claim 47, wherein the substance releasing expending gases is distributed substantially homogeneously in the adhesive layer.

56. The adhesive layer of claim 48, wherein the microballoons are distributed substantially homogeneously in the adhesive layer.

57. The adhesive layer of claim 53, wherein the substances expending as result of chemical reactions are distributed substantially homogeneously in the adhesive layer.

58. The adhesive layer of any of claim 56, wherein the substantially homogeneous distribution is present in the interior of the adhesive layer and not on the surface of in the adhesive layer.

59. The adhesive layer of claim 42, wherein the specific weight of the expanded adhesive is not more than about 70% of the weight of an unexpanded adhesive of equal thickness.

60. The adhesive layer of claim 59, wherein the specific weight is below 50% of the weight of an unexpanded adhesive of equal thickness.

61. The adhesive layer of claim 59, wherein the specific weight of the expanded adhesive layer is between about 35% and about 15% of the weight of an unexpanded adhesive of equal thickness.

62. The adhesive layer of claim 42, wherein the at least one channel has a channel wall which are precrosslinked.

63. The adhesive layer of claim 42, wherein the at least one channel has a depth greater than about 45 μm.

64. The adhesive layer of claim 42, wherein the depth of the at least one channel is greater than about 60 μm.

65. The adhesive layer of claim 42, wherein the depth of the at least one channel is greater than about 70 μm.

66. The adhesive layer of claim 42, wherein the depth of the channel is about 90 μm.

67. The adhesive layer of claim 42, wherein the at least one channel comprises a plurality of channels having each a depth of less than about 140 μm.

68. The adhesive layer of claim 42, wherein the adhesive layer has a thickness which is about 10% to about 60% greater than the depth of the at least one channel.

69. The adhesive layer of claim 42, wherein the adhesive layer has a thickness about 30%, greater than the depth of the channels.

70. The adhesive layer of claim 42, wherein the at least one channel comprises a first set of channels and a second set of channels, the channels of the first set are oriented substantially parallel to one another and the channels of the second set are oriented substantially parallel to one another, and the channels of the first set intersect the channels of the second set.

71. A sheetlike structure for a bubble-free bond, comprising
a functional layer, and
an adhesive layer, comprising a top and a bottom surface,
at least one channel disposed in the top surface of the adhesive layer and wherein the adhesive layer is an expanded layer joined to the functional layer.

72. The sheetlike structure of claim 71, wherein the top surface of the adhesive layer is covered with a liner, the liner being formed as to correspond to the surface structure of the adhesive layer.

73. The sheetlike structure of claim 72, wherein the liner has a substantially smooth surface facing the top surface of the adhesive layer.

74. The sheetlike structure of claim 71, wherein the functional layer is a carrier for the adhesive layer.

75. The sheetlike structure of claim 71, wherein the functional layer has an anti-adhesive coating.

76. A method of producing a bubble-freely bonding structure, comprising the steps of
providing a functional layer;
providing an expanded adhesive layer having a top and a bottom surface, and having least one channel provided in the top surface;
joining the functional layer to the bottom surface of the expanded adhesive layer.

77. The method of claim 76, wherein the expanded adhesive layer is prepared by introducing a substance comprising expanding gas, and subsequently releasing the expanding gas.

78. The method of claim 76, wherein the expanded adhesive layer is prepared by mixing-in microballoons and subsequently triggering expansion of the micro-balloons (6).

79. The method of claim 77, wherein the chemically reactive substances are distributed substantially homogeneously in the adhesive layer and subsequently chemically reacting these substances.

80. The method of claim 77, wherein the expanding gas are distributed substantially homogeneously.

81. The method of claim 77, wherein the substance comprising expanding gas is mixed-in homogeneously.

82. The method of claim 78, wherein the microballoons are mixed-in homogeneously.

83. The method of claim 76, further comprising the step of
providing a second adhesive layer of unexpandable or unexpanded adhesive and
applying the second adhesive layer to the adhesive layer of expandable or expanded adhesive.

84. The method of claim 76, wherein the expansion is triggered by an input of energy into the adhesive.

85. The method of claim 84, wherein the input of energy is in form of heating the adhesive layer.

86. The method of claim 76, wherein the adhesive layer is expanded following application to the functional layer.

87. The method of claim 76, wherein the adhesive layer is expanded after producing the at least one channel.

88. The method of claim 76, wherein the at least one channel is produced by embossing the adhesive.

89. The method of claim 88, wherein the embossing is accomplished by a structured liner.

90. The method of claim 76, wherein the at least one channel is provided on the top surface of the adhesive layer by laser irradiation.

91. The method of claim 76, wherein the channel walls are precrosslinked by local input of energy, preferably by laser irradiation.

92. The method of claim 91, wherein the local input of energy is laser irradiation.
